(19) United States
(12) Patent Application Publication
(10) Pub. No.: US 2024/0399898 A1
(43) Pub. Date: Dec. 5, 2024

(54) ELECTRIFIED VEHICLE INDUCTIVE AND DIRECT CONNECTION DUAL CHARGING

(71) Applicant: FCA US LLC, Auburn Hills, MI (US)

(72) Inventor: Mark J Skynar, Farmington Hills, MI (US)

(21) Appl. No.: 18/326,078

(22) Filed: May 31, 2023

(51) Int. Cl. B60L 53/10; B60L 53/12; B60L 53/16; B60L 53/20

(52) U.S. Cl. CPC B60L 53/11; B60L 53/12; B60L 53/16; B60L 53/20; B60L 2200/36; B60L 2210/10

(57) ABSTRACT

Charging control techniques for a high voltage battery system of an electrified vehicle utilizes a multi input, single output (MISO) direct current to direct current (DC-DC) charging module configured to connect to two distinct DC power sources and to the high voltage battery system and a controller configured to control the MISO DC-DC charging module to receive, from first and second DC power sources, first and second DC inputs at first and second duty cycles, respectively, merge the two DC inputs into a single DC output at a higher third duty cycle, and output the single DC output to charge the high voltage battery system, wherein the single DC output at the higher third duty cycle provides for faster charging of the high voltage battery system compared to one of the two DC inputs at the respective lower first or second duty cycles.

### FIELD

The present application generally relates to electrified vehicles and, more particularly, to techniques for inductive and direct connection dual charging of electrified vehicles.

### BACKGROUND

An electrified vehicle has an electrified powertrain including a high voltage battery system. Some electrified vehicles are configured for “plug-in” recharging of the high voltage battery system via an external charging station. Due to alternating current (AC) electrical grid limitations, conventional residential charging stations are rated at approximately 7 to 11 kilowatt hours (kWh) and provide direct current (DC) to the high voltage battery system at a maximum 50% duty cycle. This limits the charging rate/speed, which could be undesirable for certain electrified vehicles that are driven excessively and/or that utilize their high voltage battery systems for power off-loading (e.g., powering external sources, such as power tools). One potential solution is to double the size/power rating of the charging station (i.e., up to ˜22 kWh), but this significantly increases consumer costs and vehicle costs (e.g., charging module cost and size/weight). Accordingly, while such conventional electrified vehicle charging systems do work well for their intended purpose, there exists an opportunity for improvement in the relevant art.

### SUMMARY

According to one example aspect of the invention, a charging control system for a high voltage battery system of an electrified vehicle is presented. In one exemplary implementation, the charging control system comprises a multi input, single output (MISO) direct current to direct current (DC-DC) charging module configured to connect to two distinct DC power sources and to the high voltage battery system, and a controller configured to control the MISO DC-DC charging module to receive, from first and second DC power sources, first and second DC inputs at first and second duty cycles, respectively, merge the two DC inputs into a single DC output at a higher third duty cycle, and output the single DC output to charge the high voltage battery system, wherein the single DC output at the higher third duty cycle provides for faster charging of the high voltage battery system compared to one of the two DC inputs at the respective lower first or second duty cycles.

In some implementations, the controller merges the two DC inputs by synchronizing and overlaying the two DC inputs into the single DC output. In some implementations, the first DC power source is a residential charging station and the second DC power source is a wireless inductive charging pad. In some implementations, the wireless inductive charging pad is a self-aligning device that aligns itself relative to an inductive charging port on an underbody of the electrified vehicle. In some implementations, the first and second DC inputs and the single DC output are all approximately equal, and wherein the first and second duty cycles are each approximately 50 percent and the third duty cycle is approximately 100 percent.

In some implementations, the first and second DC inputs are each rated at a maximum of approximately 11 kilowatt hours (kWh) and the first and second duty cycles are each a maximum of 50 percent, and the single DC output is rated at a maximum of approximately 11 kWh and the third duty cycle is a maximum of 100 percent. In some implementations, the electrified vehicle is an extended-range electrified pickup truck. In some implementations, the extended-range electrified pickup truck is further configured for power off-loading of accessory loads including power tools. In some implementations, the first and second DC power sources are first and second residential charging stations and the electrified vehicle includes first and second plug-in charging ports.

According to another example aspect of the invention, a charging control method for a high voltage battery system of an electrified vehicle is presented. In one exemplary implementation, the method comprises providing a MISO DC-DC charging module configured to connect to two distinct DC power sources and to the high voltage battery system and controlling, by a controller, the MISO DC-DC charging module including receiving, from first and second DC power sources, first and second DC inputs at first and second duty cycles, respectively, merging the two DC inputs into a single DC output at a higher third duty cycle, and outputting the single DC output to charge the high voltage battery system, wherein the single DC output at the higher third duty cycle provides for faster charging of the high voltage battery system compared to one of the two DC inputs at the respective lower first or second duty cycles.

In some implementations, merging the two DC inputs includes synchronizing and overlaying, by the controller, the two DC inputs into the single DC output. In some implementations, the first DC power source is a residential charging station and the second DC power source is a wireless inductive charging pad. In some implementations, the wireless inductive charging pad is a self-aligning device that aligns itself relative to an inductive charging port on an underbody of the electrified vehicle. In some implementations, the first and second DC inputs and the single DC output are all approximately equal, and wherein the first and second duty cycles are each approximately 50 percent and the third duty cycle is approximately 100 percent.

In some implementations, the first and second DC inputs are each rated at a maximum of approximately 11 kWh and the first and second duty cycles are each a maximum of 50 percent, and the single DC output is rated at a maximum of approximately 11 kWh and the third duty cycle is a maximum of 100 percent. In some implementations, the electrified vehicle is an extended-range electrified pickup truck. In some implementations, the extended-range electrified pickup truck is further configured for power off-loading of accessory loads including power tools. In some implementations, the first and second DC power sources are first and second residential charging stations and the electrified vehicle includes first and second plug-in charging ports.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example charging control system for a high voltage battery system according to the principles of the present application;

FIGS. 2A-2C are example plots of two distinct direct current (DC) inputs and a merged (e.g., synchronized and overlayed) single DC output according to the principles of the present application; and

FIG. 3 is a flow diagram of an example charging control method for a high voltage battery system of an electrified vehicle according to the principles of the present application.

### DESCRIPTION

As previously discussed, due to alternating current (AC) electrical grid limitations, conventional residential charging stations are rated at approximately 7 to 11 kilowatt hours (kWh) and provide direct current (DC) to the high voltage battery system at a maximum 50% duty cycle. This limits the charging rate/speed, which could be undesirable for certain electrified vehicles that are driven excessively and/or that utilize their high voltage battery systems for power off-loading (e.g., powering external sources, such as power tools). One potential solution is to double the size/power rating of the charging station (i.e., up to ˜22 kWh), but this significantly increases consumer costs and vehicle costs (e.g., charging module cost and size/weight). This could be particularly troublesome or problematic for electrified vehicles that are driven longer distances often and, in some cases, that also perform power off-loading (e.g., powering accessory loads, such as power tools). One primary example is a range extended electrified pickup truck with power off-loading capability.

Accordingly, improved charging control techniques are presented herein that implement a multiple (multi) input, single output (MISO) DC-DC charging module with a unique master controller software (MCS) algorithm performed by a controller. The MISO DC-DC charging module is configured to receive two DC inputs from two distinct DC power sources and output a single DC output. In a primary embodiment, these two DC power sources are a residential charging station (via a conventional charging port) and a wireless inductive charging pad (via an underbody charging port). The controller's MSC algorithm merges the two DC inputs (e.g., pulse-width modulation (PWM) signals) by synchronizing and overlaying them such that the single DC output has a duty cycle of up to 100% (compared to a conventional maximum of 50%). Thus, the high voltage battery system receives twice as much current over time, thereby speeding up the charging process when desired. This allows the consumer/driver to recharge the electrified vehicle's high voltage battery system faster (when desired), thereby improving their flexibility and their overall ownership experience.

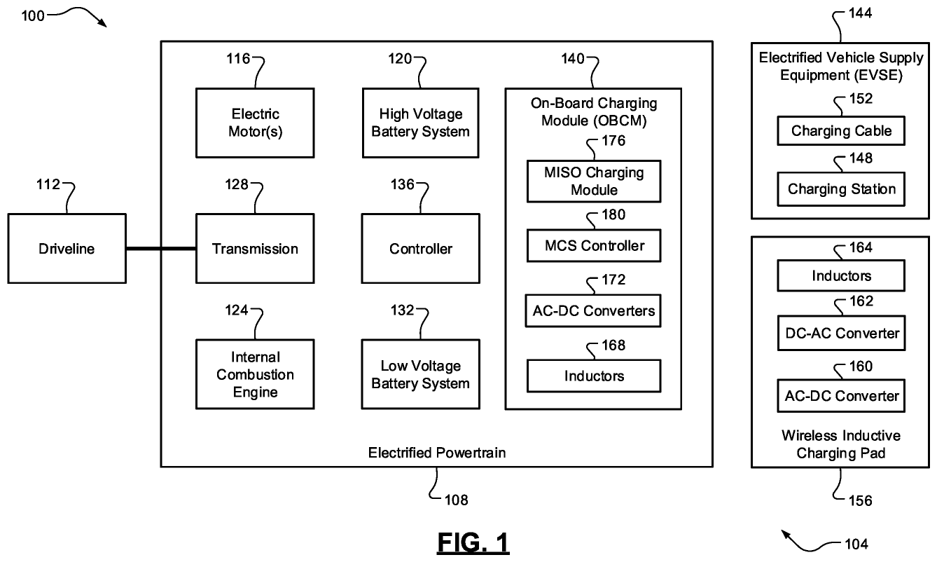

Referring now to FIG. 1, a functional block diagram of an electrified vehicle 100 having a charging control system 104 according to the principles of the present application is illustrated. The electrified vehicle 100 includes an electrified powertrain 108 configured to generate and transfer drive torque to a driveline 112 for propulsion. The electrified powertrain 108 includes one or more electric motors 116 (e.g., electric traction motors) powered by a high voltage battery system 120. The electrified powertrain 108 optionally includes an internal combustion engine 124 configured to combust a mixture of air and fuel (diesel, gasoline, etc.) to generate drive torque for vehicle propulsion and/or for generation of electrical energy (e.g., for run-time battery system recharging). A transmission 128 (e.g., a multi-speed automatic transmission) is configured to transfer the drive torque to the driveline 112. The electrified vehicle 100 also includes a low voltage (e.g., 12 volt) battery system 132, which could be used to power accessory loads (not shown) of the electrified vehicle 100. Stepping up/down the DC voltages from the battery systems 120, 132 could be performed via a DC-DC converter (not shown) for charging therebetween. A controller 140 controls operation of the electrified powertrain 108, such as controlling the electrified powertrain 108 to satisfy a driver torque request (e.g., via an accelerator pedal, not shown).

The charging control system 104 includes an on-board charging module (OBCM) 140 that acts as an intermediary between at least the high voltage battery system 120 and an external residential charging station 144 (also referred to as “electrified vehicle supply equipment 144,” or “EVSE 144”) via a plug-in charging cable 152 and a respective plug-in charging port (not shown) of the electrified vehicle 100. This EVSE 144 could be connected to AC wall/grid power at a charging box or station 148, such as at a residence of the owner/driver. The OBCM 140 is also configured to act as an intermediary between the high voltage battery system and an external wireless inductive charging pad 156. The wireless inductive charging pad 156 is also connectable to the same AC wall/grid power, but the wireless inductive charging pad 156 could be movable such that it does not need to permanently reside at the owner/driver's residence. In some implementations, the wireless inductive charging pad 156 includes robotic self-aligning features or mechanisms (not shown) that align its inductor coils or inductors 164 (connected to wall/gird power via an AC-DC converter 160) with a respective inductive charging port (not shown) on an underbody of the electrified vehicle 100. While a combination of direct (plug-in) and wireless inductive charging is specifically described herein, it will be appreciated that other combinations could be utilized provided there are the necessary ports on the electrified vehicle 100 (two residential plug-in charging stations, two wireless inductive charging pads, etc.). The described configuration of a single plug-in charging port with an optional wireless inductive charging pad, however, is a more likely combination that would be available to owners/drivers if so desired.

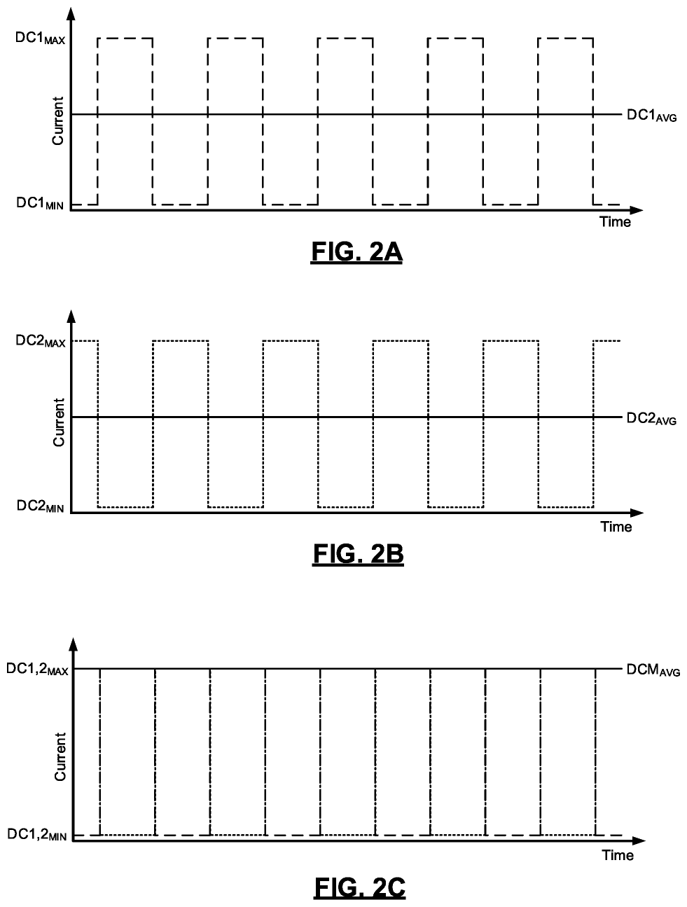

Referring now to FIGS. 2A-2C and with continued reference to FIG. 1, example plots of two distinct DC inputs and a merged (e.g., synchronized and overlayed) single DC output according to the principles of the present application are illustrated. FIGS. 2A and 2B illustrate PWM signals of two distinct DC inputs DC1 and DC2, respectively. As shown, the DC input signals DC1 and DC2 each vary between a maximum value (DC1_{MAX} and DC2_{MAX}) and a minimum value (DC1_{MIN} and DC2_{MIN}, which could be zero) at approximately a 50% duty cycle. These DC input signals have already been synchronized or aligned with each other such that their duty cycles are the opposite or do not overlap. To obtain these DC input signals DC1 and DC2, the following processes are performed by the components of FIG. 1. To obtain the first DC input signal DC1 from the EVSE 144, the charging station 148 (e.g., coupled to wall/grid power) sends, via charging cable 152, a first AC input signal to one of the AC-DC converters 172, which converts the AC input signal to the first DC input signal DC1 and it is provided to a MISO DC-DC charging module 176. To obtain the second DC input signal DC2 from the wireless inductive charging pad 156, an AC/DC converter 160 (e.g., coupled to wall/grid power) converts AC wall/grid power to a DC signal, which is then converted by a DC-AC converter 162 to a desired AC signal (e.g., desired frequency) for electromagnetic transmission between inductors 164 and 168. Another one of the AC-DC converters 172 then converts the received AC signal to the second DC input signal DC2 and it is provided to the MISO DC-DC charging module 176. The MCS controller 180, which could be part of controller 136 or separate therefrom (e.g., a standalone controller), controls the MISO DC-DC charging module 176 to align/synchronize the DC input signals DC1 and DC2 and then merge or overlay them with each other as can be seen in FIG. 2C. The result is an output or merged DC signal DCM having an average value (DCM_{AVG}) equal to DC1,2_{MAX} as it essentially is a 100% duty cycle DC signal.

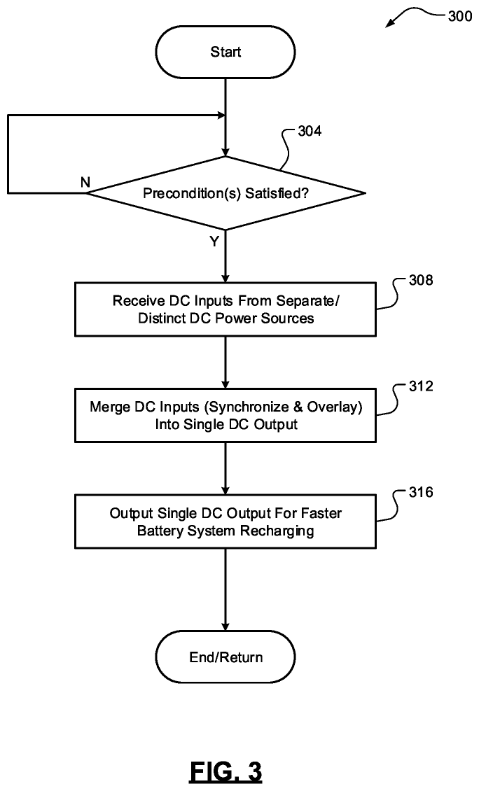

Referring now to FIG. 3, a flow diagram of an example charging control method 300 for a high voltage battery system of an electrified vehicle according to the principles of the present application is illustrated. While the electrified vehicle 100 and its components are specifically referenced for illustrative/descriptive purposes, it will be appreciated that the charging control method 300 could be applicable to any suitably configured electrified vehicle. Additionally, while the controller 136 will be referenced as performing the various operations, it will be appreciated that the MCS controller 180 could alternatively perform all or at least some of the operations described. At 304, the controller 136 determines whether a set of one or more preconditions are satisfied. This could include, for example only, the charging equipment (EVSE 144 and wireless inductive charging pad 156, if desired) being properly connected and there being no malfunctions or faults present that would otherwise prevent operation of the method 300, such as safety checks). When false, the method 300 ends or returns to 304. When true, the method 300 continues to 308. At 308, the controller 136 receives the DC inputs from separate/distinct DC power sources. At 312, the controller 136 merges (e.g., synchronizes and overlays) the DC inputs with each other to obtain a single DC output as previously described and shown herein. At 316, the controller 136 outputs the single DC output to the HV battery system 120 for faster recharging thereof. The method 300 then ends or returns to 304 for one or more additional cycles.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A charging control system for a high voltage battery system of an electrified vehicle, the charging control system comprising:
a multi input, single output (MISO) direct current to direct current (DC-DC) charging module configured to connect to two distinct DC power sources and to the high voltage battery system; and
a controller configured to control the MISO DC-DC charging module to:
receive, from first and second DC power sources, first and second DC inputs at first and second duty cycles, respectively;
merge the two DC inputs into a single DC output at a higher third duty cycle; and
output the single DC output to charge the high voltage battery system,
wherein the single DC output at the higher third duty cycle provides for faster charging of the high voltage battery system compared to one of the two DC inputs at the respective lower first or second duty cycles.

2. The charging control system of claim 1, wherein the controller merges the two DC inputs by synchronizing and overlaying the two DC inputs into the single DC output.

3. The charging control system of claim 1, wherein the first DC power source is a residential charging station and the second DC power source is a wireless inductive charging pad.

4. The charging control system of claim 3, wherein the wireless inductive charging pad is a self-aligning device that aligns itself relative to an inductive charging port on an underbody of the electrified vehicle.

5. The charging control system of claim 1, wherein the first and second DC inputs and the single DC output are all approximately equal, and wherein the first and second duty cycles are each approximately 50 percent and the third duty cycle is approximately 100 percent.

6. The charging control system of claim 5, wherein:
the first and second DC inputs are each rated at a maximum of approximately 11 kilowatt hours (kWh) and the first and second duty cycles are each a maximum of 50 percent; and
the single DC output is rated at a maximum of approximately 11 kWh and the third duty cycle is a maximum of 100 percent.

7. The charging control system of claim 1, wherein the electrified vehicle is an extended-range electrified pickup truck.

8. The charging control system of claim 7, wherein the extended-range electrified pickup truck is further configured for power off-loading of accessory loads including power tools.

9. The charging control system of claim 1, wherein the first and second DC power sources are first and second residential charging stations and the electrified vehicle includes first and second plug-in charging ports.

10. A charging control method for a high voltage battery system of an electrified vehicle, the method comprising:
providing a multi input, single output (MISO) direct current to direct current (DC-DC) charging module configured to connect to two distinct DC power sources and to the high voltage battery system; and
controlling, by a controller, the MISO DC-DC charging module including:
receiving, from first and second DC power sources, first and second DC inputs at first and second duty cycles, respectively;
merging the two DC inputs into a single DC output at a higher third duty cycle; and
outputting the single DC output to charge the high voltage battery system,
wherein the single DC output at the higher third duty cycle provides for faster charging of the high voltage battery system compared to one of the two DC inputs at the respective lower first or second duty cycles.

11. The method of claim 10, wherein merging the two DC inputs includes synchronizing and overlaying, by the controller, the two DC inputs into the single DC output.

12. The method of claim 10, wherein the first DC power source is a residential charging station and the second DC power source is a wireless inductive charging pad.

13. The method of claim 12, wherein the wireless inductive charging pad is a self-aligning device that aligns itself relative to an inductive charging port on an underbody of the electrified vehicle.

14. The method of claim 10, wherein the first and second DC inputs and the single DC output are all approximately equal, and wherein the first and second duty cycles are each approximately 50 percent and the third duty cycle is approximately 100 percent.

15. The method of claim 14, wherein:
the first and second DC inputs are each rated at a maximum of approximately 11 kilowatt hours (kWh) and the first and second duty cycles are each a maximum of 50 percent; and
the single DC output is rated at a maximum of approximately 11 kWh and the third duty cycle is a maximum of 100 percent.

16. The method of claim 10, wherein the electrified vehicle is an extended-range electrified pickup truck.

17. The method of claim 16, wherein the extended-range electrified pickup truck is further configured for power off-loading of accessory loads including power tools.

18. The method of claim 10, wherein the first and second DC power sources are first and second residential charging stations and the electrified vehicle includes first and second plug-in charging ports.
